(19) United States
(12) Patent Application Publication
(10) Pub. No.: US 2006/0080251 A1
(43) Pub. Date: Apr. 13, 2006

(54) Systems and methods for offering credit line products

(76) Inventors: Steven M. Fried, Great Neck, NY (US); Mark E. Brozek, Huntington, NY (US)

Correspondence Address: KILPATRICK STOCKTON LLP, 607 14TH STREET, N.W., WASHINGTON, DC, 20005, US

(21) Appl. No.: 11/232,627

(22) Filed: Sep. 22, 2005

Related U.S. Application Data
(60) Provisional application No. 60/611,706, filed on Sep. 22, 2004.

(51) Int. Cl. G06Q 40/00

(52) U.S. Cl. 705/42

(57) ABSTRACT

Computer implemented methods and systems for offering a credit line product to customers of a financial institution in which client household level files are created for financial institution customers, particular ones of which are then selected for a credit-line product offering based on client level and account level selection parameters, and the selected files are transferred electronically to a credit bureau. Thereafter, credit-screened account files corresponding to each of the selected client household level files with an appended credit score and credit line product terms are received from the credit bureau electronically by the financial institution for customer solicitations as determined by the credit bureau, and the customer solicitations are sent out by the financial institution.

### PRIORITY APPLICATION

This application claims priority to co-pending U.S. Provisional Application No. 60/611,706, filed Sep. 22, 2004, entitled “System and Method for Offering a Credit Line”, which is incorporated herein by this reference.

### FIELD OF THE INVENTION

The present invention relates generally to the field of credit offerings, and more particularly to methods and systems for offering credit line products to customers of a financial institution, such as a bank, that build upon existing relationships with customers or clients of the financial institution.

### BACKGROUND OF THE INVENTION

There is an on-going effort by financial institutions, or the like, to build upon existing customer relationships by offering additional services, such as credit lines, to those customers in good standing. For instance, a bank may offer one or more credit lines (e.g., credit cards, overdraft protection credit lines, home equity loans, etc.) to those customers who hold checking and/or savings accounts with the bank and have good credit ratings. In another instance, an investment institution may offer credit lines to its long-time client-investors who have good credit ratings for market trading purposes.

One problem with existing credit offering processes is the cumbersome and time-consuming steps often employed in identifying, processing, and notifying the desired customers of the credit offerings. Typically, a credit offering process at a financial institution begins with the financial institution enlisting an outside or external processing vendor to capture the institution's client database, format the captured client information as needed, and forward the formatted client information to an external screening system to screen the customers for a credit offering. The external screening system screens the customers based on criteria provided by the financial institution and forward a list of desired customers to a credit bureau (e.g., Equifax™, Experian™, Trans Union™, etc.). Typically, the external screening system manually delivers the customer list (e.g., by postal service, courier service, etc.) in the form of a magnetic or optical tape to the credit bureau. In turn, the credit bureau performs credit checks of customers identified in the received customer list and again manually delivers the credit-checked customer list to a third-party group (e.g., a commercially available credit processing system or a list processor), which is also employed by the financial institution. The third-party group provides additional customer screenings based on the credit checks and also manually delivers the finalized customer list to a direct-mail letter shop for printing and sending out offer letters to those customers identified in the finalized customer list.

To support the credit offering process, the financial institution internally creates a reservation system to receive, via phone or postal mail, acceptance of the credit offering from customers for processing. Thus, the credit offering process often takes months to process and send out offer letters to eligible customers, and the manual deliveries between various parties further add to the latency of the process. Consequently, such processing delays represent missed business opportunities for the financial institution to offer additional services to its customers, enhance the customers' experience (by providing products to the customers closer in time to their financial needs) with the financial institution, and reduce expenses to the financial institution.

### SUMMARY OF THE INVENTION

It is a feature and advantage of the present invention to provide methods and systems for offering credit line products to customers of a financial institution that streamline the credit offering process to customers, particularly, existing customers, so as to offer additional services to such customers, enhance their experience with the financial institution, and generate additional revenue for the financial institution.

To achieve the stated and other features, advantages and objects, embodiments of the present invention employ computer hardware and software, including, without limitation, instructions embodied in program code encoded on machine readable medium, to provide methods and systems for offering a credit line product to customers of a financial institution that involve, for example, creation of a client household level file for each of a plurality of financial institution customers based on an evaluation according to predetermined evaluation parameters of client information received from financial institution database systems. Client household level files for financial institution customers that are deemed eligible for consideration for a credit-line product offering are selected based, for example, on predetermined client level and account level selection parameters applied separately, and the selected files are formatted and electronically transferred to a credit bureau for credit scoring according to predetermined credit criteria.

Thereafter, according to embodiments of the invention, a credit-screened account file corresponding to each of the selected client household level files with appended credit score and credit line product terms for a customer solicitation as determined by the credit bureau is received from the credit bureau electronically by an automated credit application processing system of the financial institution, which sends a solicitation for a credit line product to each customer associated with a credit-screened account file based on the appended credit line product terms, and responses are received by the financial institution from customers who elect to accept to the credit line product solicitation.

In an embodiment of the invention, creation of a client household level file is based on an evaluation of household, client, and account level data received from the financial institution database systems. Thus, in an embodiment of the invention, creation of the file is based on an evaluation of household, client, and account level data received, for example, via a marketing database application of the financial institution from a customer account information database system of the financial institution and a customer account servicing database system of the financial institution.

In further embodiments of the invention, creation of the client household level file is based, for example, on the evaluation of the client information on a pre-determined periodic basis, and in other embodiments of the invention, creation of the file is based, for example, on the evaluation of client information according to evaluation parameters consisting at least in part of existing credit line exposure to the customer, a current deposit/investment relationship with the customer, age of the customer, and payment behavior of the customer.

In embodiments of the invention, selection of the client household level files based on the predetermined client level and account level selection parameters applied separately involves selection of files based on the predetermined client level and account level selection parameters applied separately, for example, by a financial institution screening system. In additional embodiments, selection of files based on the predetermined client level selection parameters applied separately involves file selection based on client level selection parameters consisting, for example, at least in part of a maximum number of credit lines of the customer, an amount of open asset exposure of the customer, a number of delinquencies of the customer; a number of non-sufficient funds occurrences of the customer, and a number of overdrafts of the customer.

In further embodiments of the invention, selection of the client household level files based on the predetermined client level and account level selection parameters applied separately involves file selection based on predetermined account level selection parameters consisting, for example, at least in part of a customer account status, a customer account age, a prior customer account with overdraft protection credit line, a non-sufficient fund account history, an overdraft account history, an account title format, and an account address format. In still further embodiments, client household level file selection is based, for example, on a periodic predetermined basis counting from a predetermined initial date.

In other embodiments of the invention, the credit line product terms appended to the credit-screened account file consists, for example, at least in part of an up-to amount for the customer solicitation as determined by the credit bureau and/or a monthly loan/line payment for the customer solicitation as determined by the credit bureau.

In additional embodiments of the invention, the solicitation that is sent to each customer is delivered, for example, by one or more of postal-mail letter/solicitation, statement message, note, electronic mail, and electronic message by the automated credit application processing system of the financial institution. In other embodiments, the credit line terms on which the solicitation that is sent to each customer is based are adjusted, for example, according to additional predefined screening parameters of the financial institution. In further embodiments, sending the solicitation involves, for example, setting up a reservation file for a credit line offering on an account of the customer corresponding to the appended credit line terms by the automated credit application processing system of the financial institution.

In further embodiments of the invention, receiving the customer responses involves, for example, entering customer information for each customer from whom a response is received onto a prefilled application on the automated credit application processing system of the financial institution. In additional embodiments, receiving the customer responses involves, for example, obtaining the customer's income information by the financial institution for each customer from whom a response is received. Other embodiments involve sending either a notification of approval of the credit line product with an associated account agreement or a notification of decline to each customer from whom a response is received based, for example, at least in part on the customer's income information.

Some embodiments involve sending a request for additional information by the financial institution to each customer from whom a response is received with requested information missing, and still other embodiments involve identifying each customer from whom no response is received and each customer to whom a notification of decline is sent for future review by the financial institution.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 is a flow chart that illustrates an example of the process of offering credit line products for embodiments of the invention;

FIG. 2 is a flow chart which illustrates an example of the Stage 1 aspect process of developing a client household file for embodiments of the invention;

FIG. 3 is a table that shows examples of the Stage 2 aspect client level file selection criteria for embodiments of the invention;

FIG. 4 is a table that shows examples of the Stage 2 aspect account level file selection criteria for embodiments of the invention;

FIG. 5 is a flow chart that illustrates an example of the Stage 2 aspect process of preparing the file for the credit bureau for embodiments of the invention;

FIG. 6 is a flow chart that illustrates an example of the Stage 3 aspect process of prescreen selection at the credit bureau for embodiments of the invention;

FIG. 7 is a flow chart that illustrates an example of the Stage 4 aspect process of client notification for embodiments of the invention; and

FIG. 8 is a flow chart that illustrates an example of the Stage 6 aspect ACAPS/STRATA processing for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used on another embodiment to yield a still further embodiment. Thus, it is intended that the present invention cover such modifications and variations that come within the scope of the invention.

Embodiments of the invention provide a computer implemented method and system for offering credit line products to customers that involves, for example, internalizing various customer screenings for a credit-line offering to the customers, electronically transmitting customer information to a credit bureau for credit checks, electronically receiving the credit checks from the credit bureau, internally processing the received information, and internally preparing and sending out credit-line offers to customers. According to embodiments of the system and method for offering a credit line of the present invention, a segment of customer or client accounts is reviewed against internal and external credit criteria. Those clients that meet the criteria may be solicited by postal mail, e-mail, fax, or other suitable communication means with the offer information. Those clients that are eligible but do not accept the offer as well as those that do not meet the criteria will continue to be reviewed for eligibility.

Embodiments of the invention provide a financial institution, such as a bank, a way to retain existing clients and generate additional revenue by offering credit to clients in good standing. An example embodiment described herein targets, for example, checking account customers that do not have an overdraft protection account. Thus, in an embodiment of the invention, a segment of client accounts are reviewed against internal and external credit criteria, on a monthly basis, and those clients that meet pre-defined criteria are solicited via mail with offer information. Those clients that are eligible, but do not accept the offer, as well as those that do not meet the criteria, will continue to be reviewed for eligibility.

It will be readily apparent to those skilled in the art that while the example embodiment described herein provides a credit-offering process in which the offering credit line is one that is tied to an existing customer's checking account, such as an overdraft protection credit line for the account, other types of credit lines can be offered based on any desired types of existing relationship a financial institution may have with its customers including without limitation, for example: the credit line can be a credit card offered by the financial institution to a customer that currently has a mortgage with the financial institution; the credit line can be an overdraft protection credit line on a customer's account (e.g., a check/deposit account) with the financial institution; or the credit line can be an investment credit line offered to an investor who conducts financial investments via the financial institution.

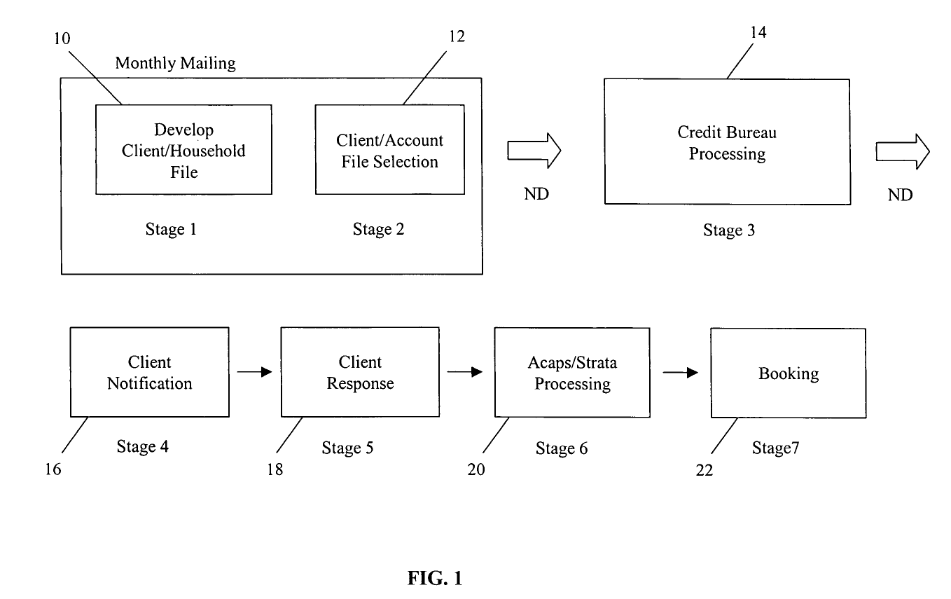

FIG. 1 is a flow chart that illustrates an example of the process of offering credit line products for embodiments of the invention. Referring to FIG. 1, embodiments of the invention involve, for example, seven “stages”. In a “Stage 1” aspect 10, a client household file is developed; in a “Stage 2” aspect 12, client/account files are selected; and a “Stage 3” aspect 14 involves prescreen selection criteria, scoring logic, and offer type. In a “Stage 4” aspect 16, clients are notified, and in a “Stage 5” aspect 18 responses are received from clients. A “Stage 6” aspect 20 involves database processing utilizing a client/account database based on applicant name/Social Security System number/reservation ID in which client information is entered onto a prefilled application on an automated credit application processing system, such as ACAPS™, and the applicant's name, Social Security No. and address are verified and income obtained, and a “Stage 7” aspect 22 involves booking an account into a customer accounting system (CAS) with a specified index (promotional pricing) if applicable.

The credit offering process for embodiments of the invention begins with the financial institution utilizing its client/account database(s) to review and identify customers that have existing relationships with the financial institution and the types of such relationships. One example of a client/account database is a SECTOR CIDBASE, a marketing database application that captures and links customer information for marketing purposes that is described in U.S. Pat. Nos. 5,966,695 and 5,930,764, incorporated herein by this reference. The Stage 1 aspect 10 and the Stage 2 aspect 12 processes are performed, for example, via SECTOR CIDBASE. SECTOR CIDBASE is a top-level database that is fed with data from other client/account databases, such as a Global Customer Information Facility (GCIF), which is a comprehensive central database system that contains and provides access to customer account information, and CAS, which is an account servicing system that services customers' accounts. A description of a GCIF can be found in U.S. Pat. No. 6,226,623, incorporated herein by this reference.

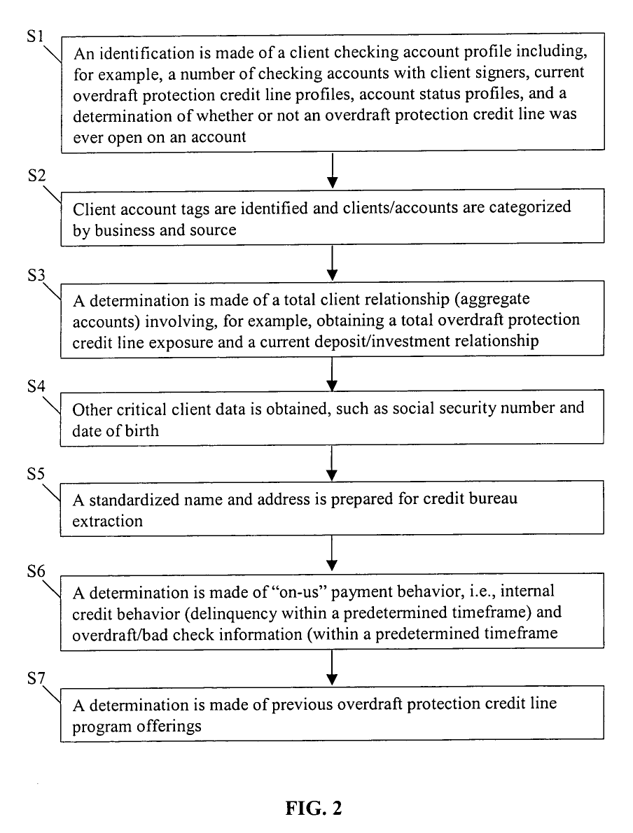

As noted above, the Stage 1 aspect 10 of the present invention involves, for example, developing a client household file in which the CAS/SECTOR CIDBASE, GCIF and other client/account databases are utilized to collect and build a file based on the required household, client, and account level data, which is reviewed on a pre-determined regular basis. The Stage 1 aspect 10 proposes, for example, a periodic (e.g., monthly) client prescreen of all client information from various financial institution systems. FIG. 2 is a flow chart which illustrates an example of the Stage 1 aspect 10 process of developing a client household file for embodiments of the invention. Referring to FIG. 2, at S1, an identification is made of a client checking account profile including, for example, a number of checking accounts with client signers, current overdraft protection credit line profiles, account status profiles, and a determination of whether or not an overdraft protection credit line was ever open on an account. At S2, client account tags are identified and clients/accounts are categorized by business and source.

Referring further to FIG. 2, at S3, a determination is made of a total client relationship (aggregate accounts) involving, for example, obtaining a total overdraft protection credit line exposure and a current deposit/investment relationship. At S4, other critical client data is obtained, such as Social Security No. and date of birth. At S5, a standardized name and address is prepared for credit bureau extraction. At S6, a determination is made of “on-us” payment behavior, i.e., internal credit behavior (delinquency within a predetermined timeframe) and overdraft/bad check information (within a predetermined timeframe), and at S7, a determination is made of previous overdraft protection credit line program offerings.

As noted above, the example embodiment described herein targets checking account customers that do not have an overdraft protection account, i.e., a checking plus account. On a periodic basis, such as monthly, a segment of client accounts is reviewed against internal and external credit criteria. Those clients that meet the criteria are solicited, for example, via mail with the offer information, and those clients that are eligible but do not accept the offer, as well as those that do not meet the criteria, will continue to be reviewed for eligibility.

In the Stage 1 aspect 10 of embodiments of the invention, Database Sales Support (DBSS) performs Stage 1 aspect 10 and Stage 2 aspect 12 consumer loan credit line offerings and creates the credit bureau files from the candidate extracts on a monthly basis. The Stage 1 aspect 10 involves, for example, the client/ household/account extract process. Utilizing, for example, SECTOR CIDBASE and other client/account databases, DBSS collects, scrubs, and builds a file based on the required household, client, and account level data employing pre-defined criteria to evaluate what accounts are selected at each interval to be sent on to the credit bureau.

From a programming perspective, the Stage 1 aspect 10 includes, but is not limited to, multiple SAS™ processes, sorts and merges, Structured Query Language (SQL) queries and match processes, and a number of external data processes that result in a pre-qualified data pool of candidates. In the Stage 2 aspect 12, DBSS produces an extract file that is transmitted electronically (e.g., via NDM) to a credit bureau for appending of additional credit scoring data, and the credit bureau transmits the file electronically (e.g. via NDM) to ACAPS. Therefore the pool of candidates is mapped to a predetermined credit bureau format. If desired, the pool can be reduced to a degree by applying additional marketing criteria/requests, such as limiting the accounts that are transmitted to the credit bureau to one or more particular types of accounts.

In embodiments of the invention, the entire client/account database may be reviewed on a periodic basis (e.g., monthly or every number of months) based on some predetermined initial date. For example, the financial institution can review each and every one of its customer accounts in the client/account database twice a year, i.e., once every six months, based on the date each account was opened. Thus, customer accounts that were opened in January are reviewed in June and again in December; customer accounts that were opened in February are reviewed in July and again next January; customer accounts that were opened in March are reviewed in August and again next February; and so on. Moreover, those customers that are eligible but do not accept the offer as well, as those that do not meet the criteria. will continue to be reviewed for eligibility.

Once the financial institution selects a list of those existing customer accounts that meet predetermined desired criteria (e.g., maximum credit exposure, minimum age requirement, etc.), the financial institution electronically forwards the account list to an internal SECTOR CIDBASE screening system for the Stage 2 aspect 12 initial screening based on additional criteria set out by the financial institution to further select the customers and generate an internally-screened account file.

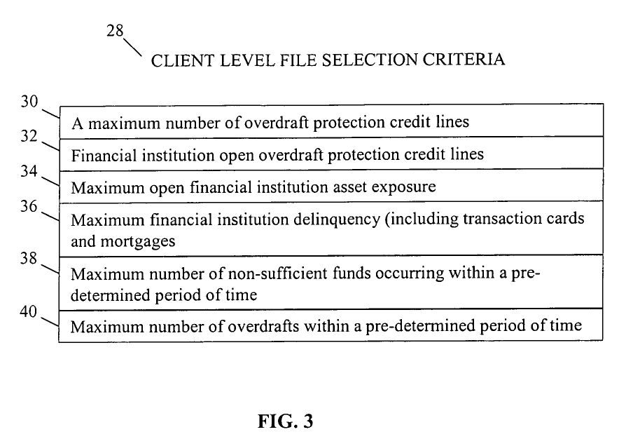

As previously mentioned, the Stage 2 aspect 12 of embodiments of the invention involves, for example, client/account file selection. In this aspect, pre-defined criteria are applied separately at a client level and at an account level. FIG. 3 is a table that shows examples of the Stage 2 aspect 12 client level file selection criteria 28 for embodiments of the invention. Referring to FIG. 3, the client level file selection criteria 28 include, for example, a maximum number of overdraft protection credit lines 30, financial institution open overdraft protection credit lines 32, maximum open financial institution asset exposure 34, maximum financial institution delinquency (including transaction cards and mortgages) 36, maximum number of non-sufficient funds occurring within a pre-determined period of time 38, and maximum number of overdrafts within a pre-determined period of time 40.

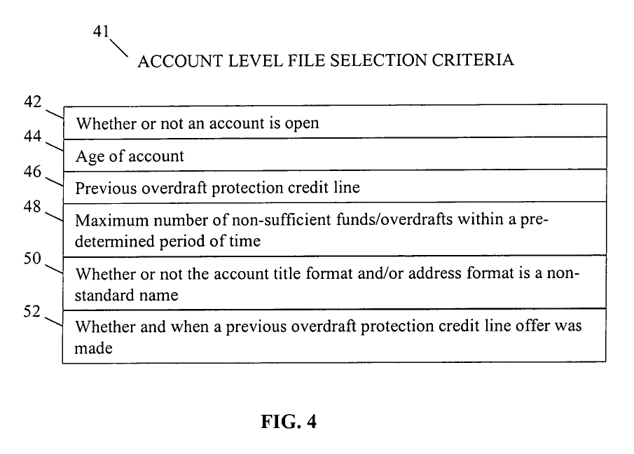

FIG. 4 is a table that shows examples of the Stage 2 aspect 12 account level file selection criteria for embodiments of the invention. Referring to FIG. 4., the Stage 2 aspect 12 account level file selection criteria 41 include, for example, whether or not an account is open 42, age of account 44, previous overdraft protection credit line 46, maximum number of non-sufficient funds/overdrafts within a pre-determined period of time 48, whether or not the account title format and/or address format is a non-standard name 50, and whether and when a previous overdraft protection credit line offer was made 52. Additional Stage 2 aspect 12 file selection criteria related to multiple accounts include for example, a maximum number of accounts on which the client is a signer, a highest deposit level/type of account criterion, and a previous offer made criterion.

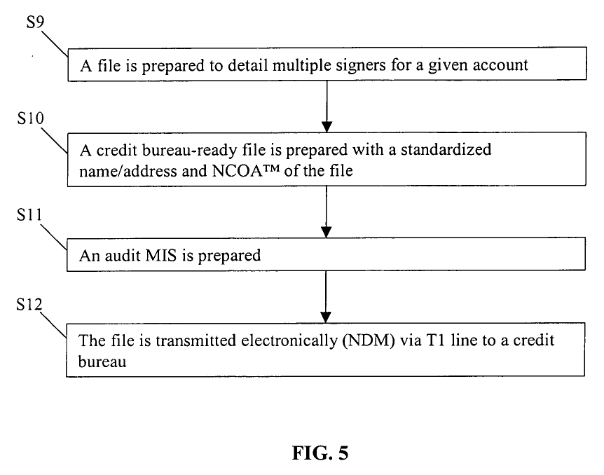

In addition, the Stage 2 aspect 12 for embodiments of the invention involves file preparation for a credit bureau in which a credit bureau-ready file is developed for credit bureau prescreen, account selection and offer determination. FIG. 5 is a flow chart that illustrates an example of the Stage 2 aspect 12 process of preparing the file for the credit bureau for embodiments of the invention. Referring to FIG. 5, at S9, a file is prepared to detail multiple signers for a given account, and at S10, a credit bureau-ready file is prepared with a standardized name/address and NCOA™ of the file, at S11, an AUDIT MIS is prepared, and at S12, the file is transmitted electronically (NDM) via TI line to a credit bureau. Thus, the internally-screened account file identifying customers that are eligible for a credit-offering program is electronically transferred to a designated credit bureau for further selection criteria based on credit checks or scores and generation of a credit-screened account file of eligible customers.

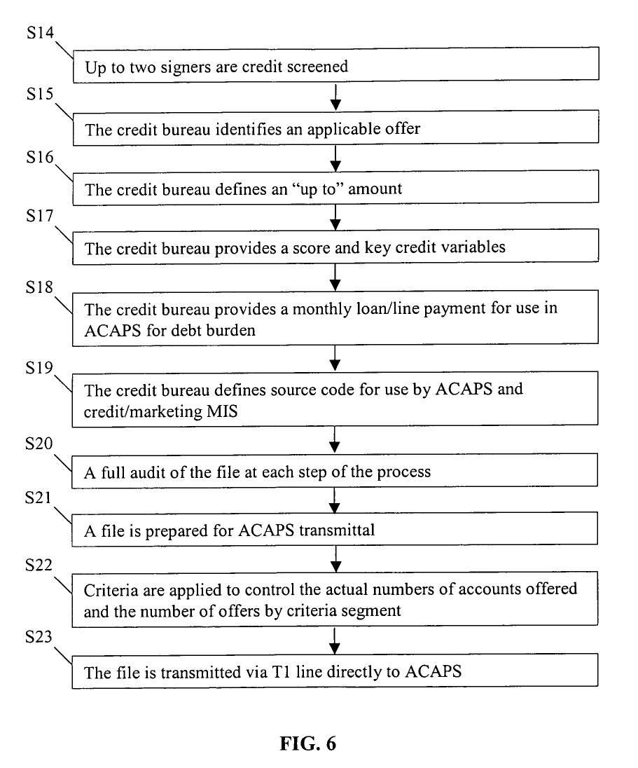

The Stage 3 aspect 14 of embodiments of the invention involves prescreen selection criteria, scoring logic, and offer type determination. Offers are made as determined at the credit bureau. FIG. 6 is a flow chart that illustrates an example of the Stage 3 aspect 14 process of prescreen selection at the credit bureau for embodiments of the invention. Referring to FIG. 6, at S14, up to two signers are credit screened, and at S15, the credit bureau identifies an applicable offer. At S16, the credit bureau defines an “up-to” amount (i.e., a maximum credit line amount), and at S17, the credit bureau provides a score and key credit variables. At S18, the credit bureau provides a monthly loan/line payment for use in ACAPS for debt burden, and at S19, the credit bureau defines source code for use by ACAPS, on which a software logic/decision-making engine, such as the STRATA™ software logic/decision-making engine, resides (ACAPS/STRATA) and credit/marketing MIS. The Stage 3 aspect 14 also involves, for example, at S20, a full audit of the file at each step of the process. At S21, a file is prepared for ACAPS transmittal, at S22, criteria are applied to control the actual numbers of accounts offered and the number of offers by criteria segment, and at S23, the file is transmitted via T1 line directly to ACAPS.

In one embodiment, the financial institution and the credit bureau are connected by a private data network to secure the electronic data transfer. In another embodiment, the financial institution and the credit bureau can be connected by a public data network, such as the Internet, with proper security encryption features known in the art to secure the electronic data transfer. Once the credit bureau generates a credit-screened account list, it then electronically forwards the credit-screened account list back to the financial institution's Automated Credit Application Processing System (ACAPS), on which a STRATA software logic/decision-making engine resides.

In the Stage 4 aspect 16, ACAPS/STRATA is internally set up by the financial institution and is responsible for additional screening (e.g., credit line amount adjustment) of the credit-screened account list based on additional criteria provided by the financial institution. The ACAPS/STRATA is also responsible for setting up a reservation file for credit-offering on the account in connection with the credit-ratings obtained from the credit bureau and for generating a finalized account list of existing customers that are eligible for a credit-line offering. ACAPS/STRATA is likewise responsible for notifying the customers (e.g., sending a letter) in the finalized account list of a credit-line offer, which can be by, but not limited to, postal-mail letter/solicitation, statement messages, notes, electronic mails, and/or electronic messages, etc.

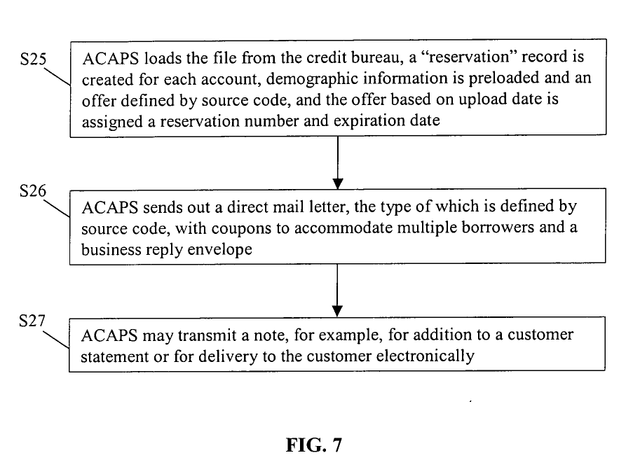

The Stage 4 aspect 16 of embodiments of the invention involves client notification in which the file is loaded into ACAPS, and clients are notified of the offer, e.g., via direct mail, statement message, or online message. FIG. 7 is a flow chart that illustrates an example of the Stage 4 aspect 16 process of client notification for embodiments of the invention. Referring to FIG. 7, at S25, ACAPS loads the file from the credit bureau, a “reservation” record is created for each account., demographic information is preloaded and an offer defined by source code, and the offer based on upload date is assigned a reservation number and expiration date. At S26, ACAPS sends out a direct mail letter, the type of which is defined by source code, with coupons to accommodate multiple borrowers and a business reply envelope. In addition, at S27, ACAPS may transmit a note, for example, for addition to a customer statement or for delivery to the customer electronically.

The Stage 5 aspect 18 of embodiments of the invention involves a receiving a response from a customer via various bank touch points using, for example a coupon or an call to a 1-800 number. When one of the notified customers responds and accepts the offer, e.g., via phone, postal mail, e-mail, the customer's response is designated to be sent back to ACAPS/STRATA for processing and subsequent notification, via postal-mail or electronic communication, of credit approval, decline, or additional information required for decision making.

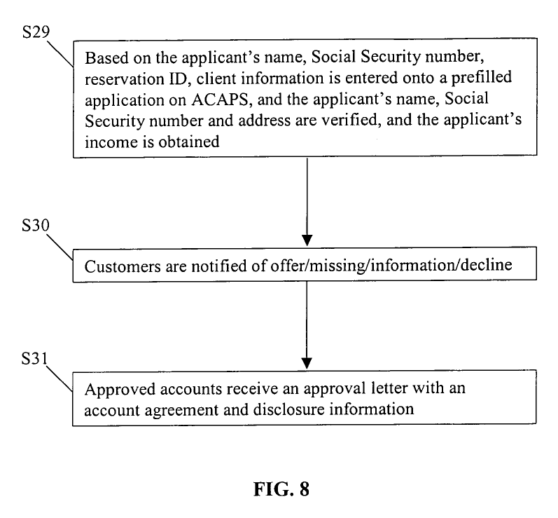

FIG. 8 is a flow chart that illustrates an example of the Stage 6 aspect 20 ACAPS/STRATA processing for embodiments of the invention. Referring to FIG. 8, at S29, based on the applicant's name/Social Security No./reservation ID, client information is entered onto a prefilled application on ACAPS, and the applicant's name, Social Security No., and address are verified, and the applicant's income is obtained. No backend credit screening is required. (i.e., credit bureau pull), and an “up-to” offer is based on debt burden. At S30, customers are notified of offer/missing/information/decline, and at S31, approved accounts receive an approval letter with an account agreement and disclosure information.

The Stage 7 aspect 22 of embodiments of the invention involves booking an account into CAS with a specified index (promo pricing ) if applicable. In order to address compliance issues with respect to notification of credit line availability, account booking is delayed by a pre-determined number of business days. For example, the ACAPS updates the SECTOR CIDBASE screening system by account booking the credit approvals, declines, additional information requirements on the SECTOR CIDBASE screening system.

Embodiments of the invention utilize ACAPS/STRATA, for example, in connection with creation of the account reservation record (application) for each account solicited for a new account from the eligible account file created by CAS and for creation of an offer letter for each client offering the client a new account. Embodiments of the invention further utilize ACAPS/STRATA in connection, for example, with offer acceptance. Thus, upon customer acceptance and application updates, ACAPS/STRATA updates the client record, for example, in respect to identifying client account segment, identify criteria/“up-to” amount pricing, and if applicable, generating a missing Information Letter.

Embodiments of the invention also utilize ACAPS/STRATA, for example, in account decisioning. Thus, an offer is dependent on the client account segment, backend decisioning is performed, no backend credit bureau criteria is required, backend debt burden calculation is performed (based on credit bureau provided data/customer stated income), and customer notification is performed based upon a decision, resulting in an approval letter or a decline letter. Embodiments of the invention likewise utilize ACAPS/STRATA, for example, in connection with account product parameters, such as line amounts, optional credit protection, auto payments from a linked account, revolving terms with payments on principal balance plus interest, variable interest rate based on prime, and fees.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A computer implemented method for offering a credit line product to customers of a financial institution, comprising:
creating a client household level file for each of a plurality of financial institution customers based on an evaluation according to predetermined evaluation parameters of client information received from financial institution database systems;
selecting client household level files for financial institution customers deemed eligible for consideration for a credit-line product offering based on predetermined client level and account level selection parameters applied separately;
formatting and electronically transferring the selected client household level files to a credit bureau for credit scoring according to predetermined credit criteria;
receiving from the credit bureau electronically by an automated credit application processing system of the financial institution a credit-screened account file corresponding to each of the selected client household level files with appended credit score and credit line product terms for a customer solicitation as determined by the credit bureau;
sending a solicitation for a credit line product to each customer associated with a credit-screened account file by the automated credit application processing system of the financial institution based on the appended credit line product terms; and
receiving responses by the financial institution from customers who elect to accept to the credit line product solicitation.

2. The method of claim 1, wherein creating the client household level file further comprises creating the client household level file based on an evaluation of household, client, and account level data received from the financial institution database systems.

3. The method of claim 1, wherein creating the client household level file further comprises creating the file based on an evaluation of household, client, and account level data received via a marketing database application of the financial institution from a customer account information database system of the financial institution and a customer account servicing database system of the financial institution.

4. The method of claim 1, wherein creating the client household level file further comprises creating the file based on the evaluation of the client information on a pre-determined periodic basis.

5. The method of claim 1, wherein creating the client household level file based on the evaluation according to predetermined evaluation parameters further comprises creating the file based on the evaluation of client information according to evaluation parameters consisting at least in part of existing credit line exposure to the customer, current deposit/investment relationship with the customer, age of the customer, and payment behavior of the customer.

6. The method of claim 1, wherein selecting the client household level files based on the predetermined client level and account level selection parameters applied separately further comprises selecting the files based on the predetermined client level and account level selection parameters applied separately by a financial institution screening system.

7. The method of claim 6, wherein selecting the client household level files based on the predetermined client level selection parameters applied separately further comprises selecting the files based on client level selection parameters consisting at least in part of a maximum number of credit lines of the customer, an amount of open asset exposure of the customer, a number delinquency of the customer; a number of non-sufficient funds occurrences of the customer, and a number of overdrafts of the customer.

8. The method of claim 6, wherein selecting the client household level files based on the predetermined client level and account level selection parameters applied separately further comprises selecting the files based on predetermined account level selection parameters consisting at least in part of a customer account status, a customer account age, a prior customer account with overdraft protection credit line, a non-sufficient fund account history, an overdraft account history, an account title format, and an account address format.

9. The method of claim 1, wherein selecting the client household level files based on the predetermined client level and account level selection parameters applied separately further comprises selecting the files based on a periodic predetermined basis counting from a predetermined initial date.

10. The method of claim 1, wherein receiving the credit-screened account file with appended credit line product terms further comprises receiving the credit-screened account file with credit line product terms consisting at least in part of an up-to amount for the customer solicitation as determined by the credit bureau.

11. The method of claim 10, wherein receiving the credit-screened account file with appended credit line product terms further comprises receiving the credit-screened account file with credit line product terms consisting at least in part of a monthly loan/line payment for the customer solicitation as determined by the credit bureau.

12. The method of claim 1, wherein sending the solicitation to each customer further comprises sending the solicitation by at least one of postal-mail letter/solicitation, statement message, note, electronic mail, and electronic message by the automated credit application processing system of the financial institution.

13. The method of claim 1, wherein sending the solicitation based on the appended credit line terms further comprises sending the solicitation based on the appended credit line terms as adjusted by the automated credit application processing system of the financial institution according to additional predefined screening parameters.

14. The method of claim 1, wherein sending the solicitation based on the appended credit line terms further comprises setting up a reservation file for a credit line offering on an account of the customer corresponding to the appended credit line terms by the automated credit application processing system of the financial institution.

15. The method of claim 1, wherein receiving the responses further comprises entering customer information for each customer from whom a response is received onto a prefilled application on the automated credit application processing system of the financial institution.

16. The method of claim 15, wherein receiving the responses further comprises obtaining the customer's income information by the financial institution for each customer from whom a response is received.

17. The method of claim 16, wherein receiving the responses further comprises sending one of a notification of approval of the credit line product with an associated account agreement and a notification of decline to each customer from whom a response is received based at least in part the customer's income information.

18. The method of claim 1, wherein receiving the responses further comprises sending a request for additional information to each customer from whom a response is received with requested information missing.

19. The method of claim 1, wherein receiving the responses further comprises identifying each customer from whom no response is received and each customer to whom is a notification of decline is sent for future review by the financial institution.

20. A machine-readable medium on which is encoded program code for offering a credit line product to customers of a financial institution, comprising instructions for:
creating a client household level file for each of a plurality of financial institution customers based on an evaluation according to predetermined evaluation parameters of client information received from financial institution database systems;
selecting client household level files for financial institution customers deemed eligible for consideration for a credit-line product offering based on predetermined client level and account level selection parameters applied separately;
formatting and electronically transferring the selected client household level files to a credit bureau for credit scoring according to predetermined credit criteria;
receiving from the credit bureau electronically by an automated credit application processing system of the financial institution a credit-screened account file corresponding to each of the selected client household level files with appended credit score and credit line product terms for a customer solicitation as determined by the credit bureau;
sending a solicitation for a credit line product to each customer associated with a credit-screened account file by the automated credit application processing system of the financial institution based on appended credit line product terms; and
receiving responses by the financial institution from customers who elect to accept to the credit line product solicitation.

21. A computer implemented system for offering a credit line product to customers of a financial institution, comprising:
means for creating a client household level file for each of a plurality of financial institution customers based on an evaluation according to predetermined criteria of client information received via a marketing database application of the financial institution from a customer account information database system of the financial institution and a customer account servicing database system of the financial institution;
means for selecting client household level files for financial institution customers deemed eligible for consideration for a credit-line product offering based on predetermined client level and account level selection parameters applied separately by a financial institution screening system;
means for formatting and electronically transferring the selected client household level files to a credit bureau for credit scoring according to predetermined credit criteria;
an automated credit application processing system preprogrammed for receiving from the credit bureau electronically a credit-screened account file corresponding to each of the selected client household level files with appended credit score and credit line product terms for a customer solicitation as determined by the credit bureau and for sending a solicitation for a credit line product to each customer associated with a credit-screened account file based on the appended credit line product terms; and
means for receiving responses from customers who elect to accept to the credit line product solicitation.
